(19) United States
(12) Patent Application Publication
(10) Pub. No.: US 2025/0056079 A1
(43) Pub. Date: Feb. 13, 2025

(54) METHOD AND APPARATUS FOR CONTROLLING CODE RATE OF LIVE STREAMING, ELECTRONIC DEVICE AND STORAGE MEDIUM

(71) Applicant: Douyin Vision Co., Ltd., Beijing (CN)

(72) Inventor: Jing LIU, Beijing (CN)

(21) Appl. No.: 18/797,249

(22) Filed: Aug. 7, 2024

(30) Foreign Application Priority Data
Aug. 7, 2023 (CN) 202310987732.3

(51) Int. Cl. H04N 21/2662; H04N 21/2187; H04N 21/2343

(52) U.S. Cl. CPC H04N 21/2662; H04N 21/2187; H04N 21/2343

(57) ABSTRACT

The present disclosure relates to a method and an apparatus for controlling a code rate of live streaming and, an electronic device and a storage medium. The method includes: obtaining code rate information of a stream push of live streaming of an application layer of a terminal; obtaining a target bandwidth estimation value obtained by a transport layer of the terminal; adjusting the target bandwidth estimation value based on the code rate information, so as to obtain an adjusted target bandwidth estimation value; and determining a target code rate of the terminal based on the adjusted target bandwidth estimation value.

### CROSS-REFERENCE TO RELATED APPLICATION(S)

This application claims priority to Chinese Application No. 202310987732.3 filed on Aug. 7, 2023, the disclosure of which is incorporated herein by reference in its entirety.

### FIELD

The present disclosure relates to the technical field of network transmission, and in particular to a method and an apparatus for controlling code rate of live streaming, an electronic device and a storage medium.

### BACKGROUND

With the continuous development of computer technologies, live video streaming is becoming increasingly popular, and many real-time live streaming services has attracted a large number of users due to their original and innovative content. Due to the decreasing end-to-end latency in live streaming services, it is necessary to quickly respond to network changes.

However, in the case of sudden fluctuation in a network bandwidth, if the encoding rate of an encoder is not adjusted in a timely manner, it is easy to result in a decreased data receiving speed of the user, thus leading to the problem of video lag.

### SUMMARY

The present disclosure provides a method and an apparatus for controlling a code rate of live streaming, an electronic device, and a storage medium.

According to one aspect of the present disclosure, provided is a method for controlling a code rate of live streaming, including:
obtaining code rate information of a stream push of live streaming in an application layer of a terminal;
obtaining a target bandwidth estimation value obtained by a transport layer of the terminal; and
adjusting the target bandwidth estimation value based on the code rate information, and determining a target code rate of the terminal based on the adjusted target bandwidth estimation value.

According to a second aspect of the present disclosure, provided is an apparatus for controlling a code rate of live streaming, including:
a code rate information acquisition module, configured to obtain code rate information of a stream push of live streaming in an application layer of a terminal;
a bandwidth estimation value acquisition module, configured to obtain a target bandwidth estimation value obtained by a transport layer of the terminal;
an adjustment module, configured to adjust the target bandwidth estimation value based on the code rate information; and
a target code rate determination module, configured to determine a target code rate of the terminal based on the adjusted target bandwidth estimation value.

According to a third aspect of the present disclosure, provided is an electronic device, including: a memory and a processor, wherein the memory stores a computer program, and the processor, when executing the program, implements the method as described above.

According to a fourth aspect of the present disclosure, provided is a computer-readable storage medium, storing a computer program thereon, wherein the program, when executed by a processor, executes the above method of the present disclosure.

The above technical solutions provided in the embodiments of the present disclosure include: obtaining code rate information of a stream push of live streaming in an application layer of a terminal; obtaining a target bandwidth estimation value obtained by a transport layer of the terminal; adjusting the target bandwidth estimation value based on the code rate information, so as to obtain an adjusted target bandwidth estimation value; and determining a target code rate of the terminal based on the adjusted target bandwidth estimation value. Since a bandwidth estimator of the transport layer may obtain feature information of the application layer, and a bandwidth estimation value estimated by the bandwidth estimator may be adjusted according to the feature information, so that the linkage between the application layer and the transport layer can be enhanced, and a change of in a network state can be adapted more actively and accurately in real time, thereby avoiding the problem of video lag.

### BRIEF DESCRIPTION OF THE DRAWINGS

More details, features and advantages of the present disclosure are disclosed in the following description of exemplary embodiments in conjunction with the drawings, wherein:

FIG. 1 is a schematic diagram of interaction between an application layer and a transport layer provided in an exemplary embodiment of the present disclosure;

FIG. 2 is a flowchart of a live streaming rate control method provided in an exemplary embodiment of the present disclosure;

FIG. 3 is a flowchart of a live streaming rate control method provided in another exemplary embodiment of the present disclosure;

FIG. 4 is a schematic block diagram of a functional module of a live streaming rate control apparatus provided in an exemplary embodiment of the present disclosure;

FIG. 5 is a structural block diagram of an electronic device provided in an exemplary embodiment of the present disclosure; and

FIG. 6 is a structural block diagram of a computer system provided in an exemplary embodiment of the present disclosure.

### DETAILED DESCRIPTION OF EMBODIMENTS

Hereinafter, embodiments of the present disclosure will be described in more detail with reference to the drawings. Although some embodiments of the present disclosure have been illustrated in the drawings, it should be understood that the present disclosure may be implemented in various forms and should not be construed as being limited to the embodiments set forth herein; and rather, these embodiments are provided to help understand the present disclosure more thoroughly and completely. It should be understood that the drawings and embodiments of the present disclosure are for exemplary purposes only and are not intended to limit the protection scope of the present disclosure.

It should be understood that, various steps recorded in method embodiments of the present disclosure may be executed in different sequences and/or in parallel. In addition, the method embodiments may include additional steps and/or omit executing the steps shown. The scope of the present disclosure is not limited in this respect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description. It should be noted that, concepts such as “first” and “second” mentioned in the present disclosure are only intended to distinguish different apparatuses, modules or units, and are not intended to limit the sequence or interdependence of functions executed by these apparatuses, modules or units.

It should be noted that, the modifiers such as “one” and “more” mentioned in the present disclosure are intended to be illustrative and not restrictive, and those skilled in the art should understand that the modifiers should be interpreted as “one or more” unless the context clearly indicates otherwise.

The names of messages or information interacted between a plurality of apparatuses in the embodiments of the present disclosure are for illustrative purposes only and are not intended to limit the scope of these messages or information.

It can be understood that, before technical solutions disclosed in the embodiments of the present disclosure are used, it is necessary to notify a user of types, usage ranges, usage scenarios and the like of personal information involved in the present disclosure in an appropriate manner according to related laws and regulations, and to obtain the authorization of the user.

For example, prompt information is sent to the user in response to receiving an initiative request of the user, so as to explicitly prompt the user that an operation which the user requests to execute needs to obtain and use the personal information of the user. Therefore, the user can autonomously choose, according to the prompt information, whether to provide the personal information for software or hardware such as an electronic device, an application program, a server or a storage medium, which executes operations of the technical solutions of the present disclosure.

In an optional but non-restrictive implementation, the manner of sending the prompt information to the user in response to receiving the initiative request of the user may be, for example, a pop-up window, and the prompt information may be presented in the pop-up window in a text manner. In addition, the pop-up window may also carry a selection control for enabling the user to choose to “agree” or “disagree” to provide the personal information for the electronic device. It can be understood that the above process of notifying and obtaining the authorization of the user is only schematic, does not constitute a limitation on the implementations of the present disclosure, and other manners satisfying related laws and regulations may also be applied to the implementations of the present disclosure.

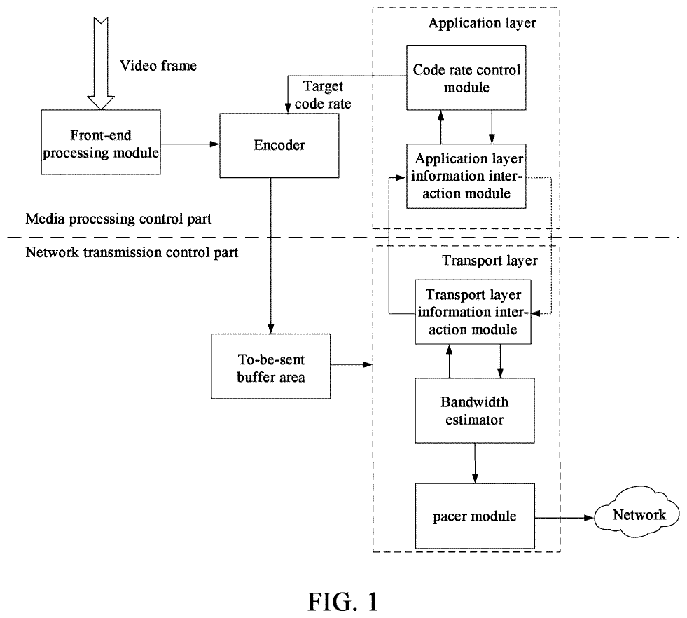

In order to more accurately respond to a change in a network state and to more quickly and more accurately obtain a bandwidth estimation value estimated by a transport layer, as shown in FIG. 1, the embodiments of the present disclosure may include information interaction between an application layer and the transport layer.

As shown in FIG. 1, the application layer may include an application layer information interaction module and a code rate control module, and the transport layer includes a transport layer information interaction module and a bandwidth estimator, wherein:

the application layer information interaction module is configured to obtain feature information sent by the transport layer information interaction module, wherein the feature information includes a bandwidth estimation value estimated by the bandwidth estimator of the transport layer;

the code rate control module is configured to calculate a target code rate within a next period according to information such as the bandwidth estimation value, a code table and a resolution, and input the target code rate to an encoder;

the transport layer information interaction module is configured to obtain the feature information sent by the application layer information interaction module, wherein the feature information includes QoS (Quality of Service) requirement and change information of the application layer, specifically including a resolution, a code table, or a frame rate, and the like; and

the bandwidth estimator is configured to estimate a bandwidth estimation value with the next period according to the obtained QoS requirement and change information of the application layer, send the bandwidth estimation value to the application layer code rate control module on one hand, and output a sending rate based on the bandwidth estimation value for the transmission of media data. In the embodiments, the bandwidth estimator may execute, including, but not limited to, TCC (Transport-Wide Congestion Control), GCC (Google Congestion Control), variant algorithms thereof, etc.

In terms of the transport layer, as shown in FIG. 1, the transport layer information interaction module may obtain the feature information sent by the application layer information interaction module according to a preset period, and the feature information may include the QOS requirement information and QoS change information of the application layer; and by using the feature information as an external input of the bandwidth estimator of the transport layer, after estimation is performed by the bandwidth estimator, the bandwidth estimation value with the next period is output, meanwhile, the bandwidth estimation value is used as an input of a pacer module to estimate an actual sending rate pacing_rate of a UDP (User Datagram Protocol) transmission protocol, and data read from a to-be-sent buffer area is sent to a network according to the pacing_rate.

In the embodiments, the bandwidth estimation value output by the bandwidth estimator may be dynamically adjusted according to the resolution of a video frame of a video to be transmitted of the application layer and a lower code rate limit value of a code table corresponding to the resolution of the video frame, so that a minimum value min_bwe of the bandwidth estimation value cannot be less than the lower code rate limit value min_bitrate of the corresponding code table, that is, min_bwe>=min_bitrate; the actual sending rate pacing_rate-bandwidth estimation value bwe*pacing gain, wherein pacing gain is a parameter, which may be set according to actual situations, for example, may be an empirical value, and the pacing gain generally should be greater than or equal to 1.

In terms of the application layer, as shown in FIG. 1, the application layer information interaction module obtains the feature information sent by the transport layer information interaction module according to a preset period, and the feature information may include the bandwidth estimation value estimated by the bandwidth estimator of the transport layer. By using the feature information as an external input of the application layer code rate control module, the target code rate within the next period may be output after being calculated by the application layer code rate control module; an output of original video frame data after undergoing rendering process of a front-end processing module on the video frame is used as the input of the encoder together with the target code rate, encoded data is output by the encoder, and the encoded data is sent to the to-be-sent buffer area to be subjected to traffic smoothing by the pacer module of the transport layer, and then is sent to the network by an RTP (Real-Time Transport Protocol).

In the embodiments, the target code rate output by the application layer code rate control module should be between the upper code rate limit value and the lower code rate limit value of the code table of the corresponding resolution, that is, the lower code rate limit value min_bitrate <=the target code rate <=the upper code rate limit value max_bitrate, when |a target code rate within a previous period−a bandwidth estimation value within a current period|/the target code rate within the previous period >=2%, the bandwidth estimation value within the current period is used as the target code rate within the current period, and otherwise, the target code rate within the current period still maintains the target code rate within the previous period, that is, the target code rate within the previous period is used as the target code rate within the current period.

In the embodiments of the present disclosure, a more accurate response may be made to a change in a network state, thereby having relatively high anti-random packet loss capability; and in addition, the bandwidth estimator of the application layer may obtain the QoS requirement and change information of a code rate control policy of the application layer, so that the linkage between code rate control and bandwidth estimation can be enhanced. Moreover, since the application layer code rate control module may obtain the bandwidth estimation value estimated by the bandwidth estimator of the transport layer in an application state, compared with TCP-based passive estimation on the application layer, a bandwidth value may be estimated by the bandwidth estimator, so that the change in the network state can be adapted to more actively and accurately in real time.

Since bandwidth estimation is one of the most important parts of WebRTC (Web Real-Time Communications), and is mainly used for deciding how many video code rates are allowed to be sent into the network without causing network congestion. The bandwidth estimation method in the WebRTC includes two algorithms, that is, GCC and TCC. A receiving-end controller of the GCC is an algorithm based on a delay signal. The TCC mainly improves the GCC algorithm, and main modification points include releasing the receiving-end controller to a sending end, and changing a new overload detector from Kalman filtering estimation to a trend line estimation method.

Since the WebRTC is originally designed for real-time communication between different browsers, the requirement for application scenarios thereof is an ultra-low delay, which generally should be within 250 ms. In order to meet the ultra-low delay requirement, the design principle for the bandwidth estimation algorithm thereof is delay sensitive, which is reflected in that when the algorithm detects any congestion signal, for example, when the delay becomes greater or a packet loss rate is increased, the video transmission is greatly reduced immediately.

When the WebRTC is applied to a low-latency stream push of live streaming scenario, the above delay-sensitive design principle often greatly reduces the bandwidth estimation value due to misjudgment resulting from network jitter in reality, so that the stream push of live streaming often encounters a blurring picture problem, that is, when the video transmission is greatly reduced, a corresponding video encoding rate is greatly reduced to lead to an insufficient code rate, resulting in fuzzy distortion of video image quality. The main cause is that the trend line estimation algorithm of the bandwidth estimation algorithm TCC is inaccurate.

Therefore, in order to further improve the accuracy of the bandwidth estimation value estimated by the bandwidth estimator, in the embodiments of the present disclosure, the estimated bandwidth estimation value is corrected to solve the problem of picture blurring of bandwidth live streaming caused by the misjudgment of the bandwidth estimation algorithm.

In the embodiments of the present disclosure, by introducing a bandwidth oscillation fluctuation mode and determining, by the bandwidth estimation value estimated by the bandwidth estimator, whether the bandwidth estimator enters the bandwidth oscillation fluctuation mode, and if the bandwidth estimator enters the bandwidth oscillation fluctuation mode, it indicates that the bandwidth estimation value estimated by the bandwidth estimator exhibits consecutive sharp decreases, and therefore the bandwidth estimation value corresponding to the bandwidth oscillation fluctuation mode needs to be corrected.

In the embodiments, the bandwidth estimator may be a TCC bandwidth estimator, that is, the bandwidth estimator may check, on the basis of a bandwidth estimation value obtained by the TCC algorithm, the bandwidth estimation value estimated by the bandwidth estimator, so as to determine whether the bandwidth estimation value within a target time period estimated by the bandwidth estimator belongs to the bandwidth oscillation fluctuation mode, if so, it indicates that the bandwidth estimator has entered the bandwidth oscillation fluctuation mode within the target time period, and thus it is necessary to correct the bandwidth estimation value within the target time period, wherein the target time period may be a current period of time.

Specifically, the target time period may include a plurality of consecutive bandwidth estimation values, and whether the bandwidth estimator enters the bandwidth oscillation fluctuation mode within the target time period may be determined in the following manner:
1) multiple consecutive sharp decreases occur in the bandwidth estimation value within the target time period, and a time interval between twice sharp decreases is less than a preset time interval, which may be, for example, 60s;
2) the sharp decrease refers to that the (i-1)^{th} bandwidth estimation value/the i^{th} bandwidth estimation value >=1-x %, wherein i is a positive integer greater than 1, for example, when x=20, a descent range of the sharp decrease In the embodiments exceeds 20%; and
3) the number of sharp decreases within a unit time is greater than a preset number.

Therefore, In the embodiments, based on the oscillation fluctuation mode, the bandwidth estimation values in the oscillation fluctuation mode may be detected and corrected.

After an initial stage (a detection stage) of an original TCC bandwidth estimator, an oscillation fluctuation detection module switch is enabled, and when the oscillation fluctuation mode is not detected, that is, it is in a normal mode, a bandwidth value target_bitrate obtained by the current TCC bandwidth estimator is not processed, and is directly transmitted to the pacer module to be sent to the network; and when the oscillation fluctuation mode is detected, a first-order filtering module performs smoothing processing on the current bandwidth estimation value to obtain a new bandwidth estimation value new_target_bitrate, and then transmits the new bandwidth estimation value to the pacer module to be sent to the network.

In the embodiments of the present disclosure, the detection of the oscillation fluctuation mode by an oscillation fluctuation detection module may include the following steps:
1) starting timing when it is detected that a descend range of the i^{th} bandwidth estimation value than the (i-1)^{th} bandwidth estimation value within the target time period exceeds a preset threshold, wherein the i^{th} bandwidth estimation value is a bandwidth estimation value when a significant decrease occurs within the target time period for the first time, for example, when a previous bandwidth estimation value/a current bandwidth estimation value >=1-x %, counting is started, and a timestamp at this time is recorded;
2) if a sharp decrease (i.e., the descent range exceeds a preset threshold compared with the previous bandwidth estimation) occurs again within a preset time period (e.g., y seconds) after the timestamp, adding 1 to the count, and updating the timestamp;
3) when the obtained count does not exceed a certain value z, and no significant decrease occurs within y seconds, returning the count to 0, returning the timestamp to 1, and restarting the counting until a significant decrease occurs in the bandwidth estimation value again;
4) when the counter exceeds z, that is, the bandwidth oscillation fluctuation mode is identified at this time, subsequent bandwidth estimation values enter the first-order filtering module for smoothing processing, that is, eliminating the bandwidth oscillation fluctuation phenomenon;
5) after entering the first-order filtering module, starting countdown for y seconds, and if a significant decrease occurs within the countdown again, resetting the countdown, updating the timestamp, and adding 1 to the count; and
6) if no significant decrease occurs at the end of the countdown, exiting the first-order filtering module, returning the count to 0, returning the timestamp to −1, and restarting the above steps until a next significant decrease occurs.

The first-order filtering module processes the bandwidth estimation value in the following manner:
if a target code rate target_bitrate obtained by the bandwidth estimator according to an output bandwidth estimation value <the current target code rate current_target_bitrate, a final new target code rate new_target_bitrate=bwe_smoothing_coef*current_target_bitrate+(1-bwe_smoothing_coef) *target_bitrate, wherein bwe_smoothing_coef denotes a bandwidth smoothing factor coefficient.

It should be noted that in the embodiments, the bandwidth estimator may be configured to obtain, in real time, the bandwidth value target_bitrate estimated by the TCC algorithm; and the oscillation fluctuation detection module may be configured to identify whether the bandwidth estimator enters the oscillation fluctuation mode online; the first-order filtering module may be configured to smoothly correct an erroneous bandwidth value output by the original bandwidth estimator in the identified oscillation fluctuation scenario, and modify the erroneous bandwidth value to obtain a corrected bandwidth estimation value new_target_bitrate; and a pacer may be configured to perform network transmission at a constant speed according to the final bandwidth value, perform the final bandwidth value according to the new_target_bitrate when the oscillation fluctuation mode is identified, and perform the final bandwidth value according to target_bitrate output by the bandwidth estimator when the oscillation fluctuation mode is not identified.

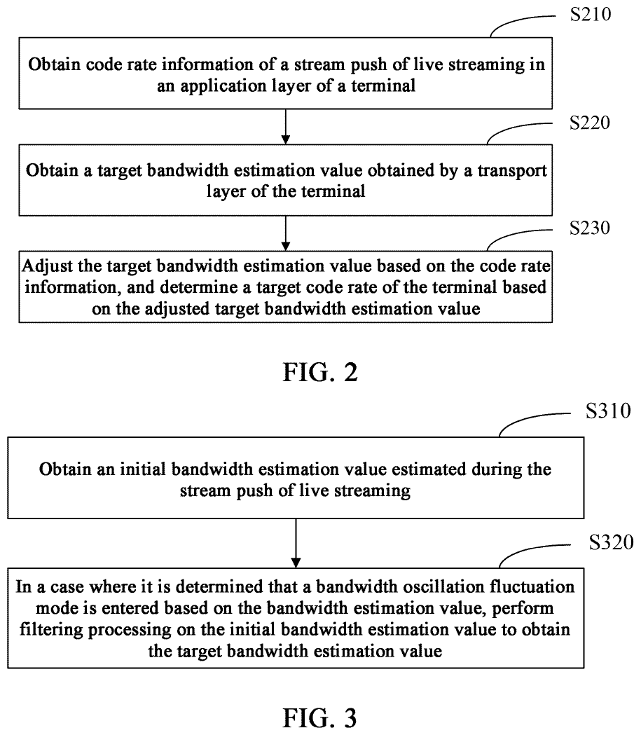

Based on the above embodiments, in another embodiment provided in the present disclosure, as shown in FIG. 2, a method for controlling a code rate of live streaming is further provided, and the method includes the following steps:

Step S210: code rate information of a stream push of live streaming in an application layer of a terminal is obtained.

In combination with FIG. 1 and corresponding embodiments, information interaction may be performed between the application layer and a transport layer by respective corresponding information interaction models. In the embodiments, the code rate information of the stream push of live streaming in the application layer may be feature information such as QoS requirement information and Qos change information in the above embodiments, for example, the QoS requirement information may be the minimum code rate of the current stream push of live streaming, and the QoS requirement change information may be an adjustment change value of the minimum code rate of the current stream push of live streaming.

Step S220: a target bandwidth estimation value obtained by the transport layer of the terminal is obtained.

In the embodiments, the bandwidth estimation value obtained by the transport layer may be a value estimated directly by the bandwidth estimator in the above embodiments, and the obtained target bandwidth estimation value may also be detected and corrected by the bandwidth estimation value estimated by the bandwidth estimator in the above embodiments by using a bandwidth oscillation fluctuation mode.

Step S230: the target bandwidth estimation value is adjusted based on the code rate information, and a target code rate of the terminal is determined based on the adjusted target bandwidth estimation value.

In the embodiments, the bandwidth estimator of the transport layer may obtain the feature information of the application layer, and may adjust, according to the feature information, the target bandwidth estimation value estimated by the bandwidth estimator, so that the linkage between the application layer and the transport layer can be enhanced. In addition, since the application layer may obtain, when performing code rate control, the target bandwidth estimation value estimated by the bandwidth estimator of the transport layer, compared with TCP-based passive estimation on the application layer, a bandwidth value may be estimated by the bandwidth estimator, so that a change in a network state can be adapted to more actively and accurately in real time.

Based on the above embodiments, in yet another embodiment provided in the present disclosure, the above step S230 may further include the following steps: Step S231: a target resolution corresponding to a video frame to be transmitted is obtained.

In the embodiments, the video to be transmitted has a corresponding target resolution, such as 1080P or 720P.

Step S232: a target code table corresponding to the target resolution is obtained.

The target code table includes an upper code rate limit value and a lower code rate limit value, and different resolutions correspond to different code tables.

Step S233, in a case where the target bandwidth estimation value is less than the lower code rate limit value, the target bandwidth estimation value is adjusted based on the lower code rate limit value.

In the embodiments, video frames of different resolutions may correspond to different code tables, and the different code tables includes different lower code rate limit values and different upper code rate limit values. For example, the upper code rate limit value of a code table corresponding to a resolution of 1080 P may be 3.8 Mbps, the lower code rate limit value may be 1.5 Mbps, and the upper code rate limit value and the lower code rate limit value of a code table corresponding to a resolution of 720 P are less than those of the 1080 P.

In this way, by obtaining code tables corresponding to different resolutions, in a case where the obtained target bandwidth estimation value is relatively low, the target bandwidth estimation value may be optimized by the lower code rate limit value corresponding to the code table, thereby avoiding the resolution of a video being too low due to the fact that the target bandwidth estimation value is lower than the lower code rate limit value corresponding to the code table.

Based on the above embodiments, in yet another embodiment provided in the present disclosure, the above step S230 may further include the following steps:

Step S234: a first code rate corresponding to the (i-1)^{th} period is obtained.

The target bandwidth estimation value is obtained within the i^{th} period, and i is a positive integer greater than 1.

In the embodiments, target bandwidth estimation values respectively corresponding to a plurality of periods may be obtained, and each period may include a specific duration.

For example, the current period may be used as the i^{th} period, and the target bandwidth estimation value may be obtained within the i^{th} period. The (i-1)^{th} period is a historical period adjacent to the current period in a historical stage, and the target bandwidth estimation value within the current period may be adjusted by obtaining the first code rate corresponding to the (i-1)^{th} period.

Step S235: a code rate change value is obtained based on the first code rate and the target bandwidth estimation value.

Step S236: in a case where the code rate change value is not greater than a change threshold, the first code rate is used as the adjusted target bandwidth estimation value.

In the embodiments, the code rate change value may be obtained by |the target code rate within the previous period−the bandwidth estimation value within the current period|/the target code rate within the previous period, and when the code rate change value is greater than or equal to the change threshold, the bandwidth estimation value obtained within the current period may be used as the target code rate within the current period. If the code rate change value is less than the change threshold, the bandwidth estimation value within the current period may be adjusted according to the target code rate (i.e., the first code rate) within the previous period (i.e., the (i-1)^{th} period), for example, the first code rate may be used as the adjusted target bandwidth estimation value, and the first code rate may be used as the target code rate within the i^{th} period. For example, the code rate change value may be 2%, the code rate change value may be set according to actual needs, and the embodiments are not limited thereto.

Based on the above embodiments, in yet another embodiment provided in the present disclosure, as shown in FIG. 3, the method may include the following steps:

Step S310: an initial bandwidth estimation value estimated is obtained during the stream push of live streaming.

Step S320: in a case where it is determined that the bandwidth oscillation fluctuation mode is entered based on the bandwidth estimation value, a filtering processing on the initial bandwidth estimation value to obtain the target bandwidth estimation value is performed.

The bandwidth oscillation fluctuation mode represents a decrease situation of the bandwidth estimation value within a unit time period.

In the embodiments, the initial bandwidth estimation value may be a value estimated by the bandwidth estimator, and since the bandwidth oscillation fluctuation mode represents the decrease situation of the bandwidth estimation value within the unit time period, if consecutive sharp decreases occur in the initial bandwidth estimation value estimated by the bandwidth estimator, the problem of a blurred video picture is cause due to an excessively low target code rate. For example, when the bandwidth estimator performs bandwidth estimation based on the TCC algorithm, and when the TCC algorithm detects any congestion signal, for example, when the delay becomes greater or the packet loss rate is increased, the video transmission is greatly reduced immediately, thereby affecting the quality of the video picture.

Therefore, it is necessary to determine the bandwidth estimation value obtained in the stream push of live streaming process, so as to determine whether the bandwidth oscillation fluctuation mode is entered, and if the bandwidth oscillation fluctuation mode is not entered, the initial bandwidth estimation value may be used as the target bandwidth estimation value. If the bandwidth oscillation fluctuation mode is entered, it indicates that consecutive sharp decreases occur in the bandwidth estimation value, therefore alignment and correction need to be performed to avoid affecting the quality of the transmitted video picture.

In the embodiments, the initial bandwidth estimation value includes a plurality of bandwidth estimation values obtained according to a time sequence, and whether the bandwidth oscillation fluctuation mode is entered may be determined in the following manner: obtaining decrease values between every two adjacent bandwidth estimation values among the plurality of bandwidth estimation values; in a case where there is a target decrease value greater than a decrease threshold among the decrease values, obtaining an interval duration for the occurrence of the target decrease value; in a case where the interval duration is less than a threshold duration, obtaining the number of occurrence times of the target decrease value within a unit time; and in a case where the number of occurrence times of the target decrease value is greater than a threshold of the number of occurrence times, determining that the bandwidth oscillation fluctuation mode is entered.

For example, in a case where multiple consecutive sharp decreases occur in the bandwidth estimation value within the target time period, a time interval between twice sharp decreases is less than, for example, 60s, the descent gradient of the twice sharp decreases exceeds, for example, 20%, and the number of appease decreases within the target time period is greater than a certain number of times, and the like, whether the bandwidth oscillation fluctuation mode is entered may be determined based on the initial bandwidth estimation value, and if the bandwidth oscillation fluctuation mode is entered, the initial bandwidth estimation value needs to be corrected.

In the embodiments, in order to accurately detect whether the bandwidth oscillation fluctuation mode is entered, it is also necessary to detect whether the current stage is a starting stage. That is, whether the current stage is in the starting stage is determined based on the initial bandwidth estimation value, wherein the starting stage includes that the initial bandwidth estimation value is in a consecutive increase state; and in a case where the current stage is not in the starting stage, it is determined whether the bandwidth oscillation fluctuation mode is entered. Since the estimation value estimated by the bandwidth estimator in the starting stage is still in a consecutive adjustment stage, the detection of the bandwidth oscillation fluctuation mode may be performed after the starting stage, so that the result is more accurate.

In the embodiments, when the bandwidth oscillation fluctuation mode is entered, it is necessary to perform filtering processing on the initial bandwidth estimation value, so as to correct the same. Specifically, a current code rate of the stream push of live streaming may be obtained, and the target bandwidth estimation value is determined based on the current code rate, the initial bandwidth estimation value, and a preset bandwidth smoothing factor coefficient. For example, reference may be made to the processing manner of the bandwidth estimation value by the first-order filtering module in the above embodiments, thus details are not described herein again.

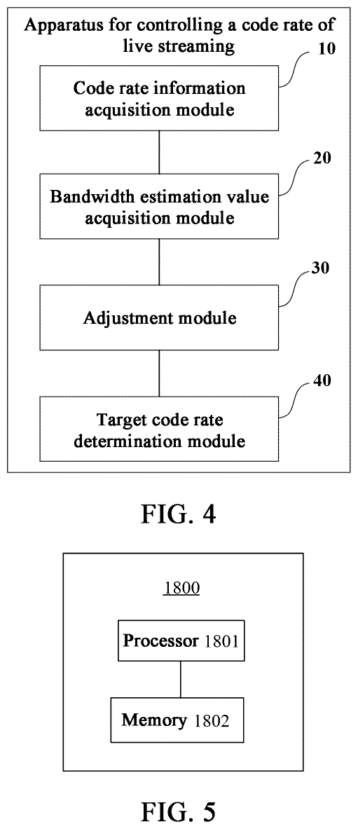

In a case where functional modules are divided corresponding to functions, an embodiment of the present disclosure provides an apparatus for controlling a code rate of live streaming, wherein the apparatus for controlling a code rate of live streaming may be a server or a chip applied to the server. FIG. 4 is a schematic block diagram of functional modules of a apparatus for controlling a code rate of live streaming provided in an exemplary embodiment of the present disclosure. As shown in FIG. 4, the apparatus for controlling a code rate of live streaming apparatus includes:
a code rate information acquisition module 10, configured to obtain code rate information of a stream push of live streaming in an application layer of a terminal;
a bandwidth estimation value acquisition module 20, configured to obtain a target bandwidth estimation value obtained by a transport layer of the terminal;
an adjustment module 30, configured to adjust the target bandwidth estimation value based on the code rate information, so as to obtain an adjusted target bandwidth estimation value; and
a target code rate determination module 40, configured to determine a target code rate of the terminal based on the adjusted target bandwidth estimation value.

In yet another embodiment provided in the present disclosure, the adjustment module is specifically configured to:
obtain a target resolution corresponding to a video frame to be transmitted;
obtain a target code table corresponding to the target resolution, wherein the target code table includes an upper code rate limit value and a lower code rate limit value, and different resolutions correspond to different code tables; and
in a case where the target bandwidth estimation value is less than the lower code rate limit value, adjust the target bandwidth estimation value based on the lower code rate limit value.

In yet another embodiment provided in the present disclosure, the adjustment module is further specifically configured to:
obtain a first code rate corresponding to the (i-1)^{th} period, wherein the target bandwidth estimation value is obtained within the i^{th} period, and i is a positive integer greater than 1;
obtain a code rate change value based on the first code rate and the target bandwidth estimation value; and
in a case where the code rate change value is not greater than a change threshold, use the first code rate as the adjusted target bandwidth estimation value.

In yet another embodiment provided in the present disclosure, the apparatus further includes:
an initial bandwidth estimation value acquisition module, configured to obtain an initial bandwidth estimation value estimated during stream push of live streaming; and
a filtering module, configured to: in a case where it is determined based on the bandwidth estimation value that the bandwidth oscillation fluctuation mode is entered, perform filtering processing on the initial bandwidth estimation value to obtain the target bandwidth estimation value, wherein the bandwidth oscillation fluctuation mode represents a decrease situation of the bandwidth estimation value within a unit time period.

In yet another embodiment provided in the present disclosure, the initial bandwidth estimation value includes a plurality of bandwidth estimation values obtained according to a time sequence, and the apparatus further includes:
a decrease value acquisition module, configured to obtain decrease values between every two adjacent bandwidth estimation values among the plurality of bandwidth estimation values;
an interval duration acquisition module, configured to: in a case where there is a target decrease value greater than a decrease threshold among the decrease values, obtain an interval duration for the occurrence of the target decrease value;
a decrease number acquisition module, configured to: in a case where the interval duration is less than a threshold duration, obtain the number of occurrence times of the target decrease value within a unit time; and
a mode determination module, configured to: in a case where the number of occurrence times is greater than a threshold of the number of occurrence times, determine that the bandwidth oscillation fluctuation mode is entered.

In yet another embodiment provided in the present disclosure, the apparatus further includes:
a starting stage determining module, configured to determine, based on the initial bandwidth estimation value, whether the current stage is a starting stage, wherein the starting stage includes that the initial bandwidth estimation value is in a consecutive increase state; and
a bandwidth oscillation fluctuation mode determination module, configured to: in a case where the current stage is not in the starting stage, determine whether the bandwidth oscillation fluctuation mode is entered.

In yet another embodiment provided in the present disclosure, the filtering module is specifically configured to:
obtain a current code rate of the stream push of live streaming; and
determine the target bandwidth estimation value based on the current code rate, the initial bandwidth estimation value, and a preset bandwidth smoothing factor coefficient.

In yet another embodiment provided in the present disclosure, the apparatus further includes:
a target bandwidth estimation value determination module, configured to: use the initial bandwidth estimation value as the target bandwidth estimation value in a case where the bandwidth oscillation fluctuation mode is not entered.

In the above technical solution provided in the embodiments of the present disclosure, the bandwidth estimator of the transport layer may obtain the QoS requirement and change information of a code rate control policy of the application layer, so that the linkage between the application layer and the transport layer can be enhanced. Moreover, since the application layer code rate control module may obtain the bandwidth estimation value estimated by the bandwidth estimator of the transport layer in an application state, compared with TCP-based passive estimation on the application layer, a bandwidth value may be estimated by the bandwidth estimator, so that a change in a network state can be adapted to more actively and accurately in real time.

In addition, the initial bandwidth estimation value estimated during the stream push of live streaming may be further obtained, and in a case where it is determined based on the bandwidth estimation value that the bandwidth oscillation fluctuation mode is entered, filtering processing is performed on the initial bandwidth estimation value to obtain the target bandwidth estimation value. By introducing the bandwidth oscillation fluctuation mode, when it is determined according to the obtained bandwidth estimation value that the bandwidth oscillation fluctuation mode is entered, the bandwidth estimation value is corrected, so that the problem of the target code rate being excessively low due to a sharp decrease in the bandwidth estimation value can be avoided. In this way, the problem of a blurred picture in the stream push of live streaming can be avoided, and the video picture of the stream push of live streaming can be controlled to maintain a corresponding definition.

An embodiment of the present disclosure further provides an electronic device, including: at least one processor; and a memory, configured to store an instruction executable by the at least one processor, wherein the at least one processor is configured to execute the instruction, so as to implement the method disclosed in the embodiments of the present disclosure.

FIG. 5 is a schematic structural diagram of an electronic device provided in an exemplary embodiment of the present disclosure. As shown in FIG. 5, the electronic device 1800 includes at least one processor 1801 and a memory 1802 coupled to the processor 1801, and the processor 1801 may execute corresponding steps in the above method disclosed in the embodiments of the present disclosure.

The processor 1801 may also be referred to as a central processing unit (CPU), which may be an integrated circuit chip and has a signal processing capability. The steps in the above method disclosed in the embodiments of the present disclosure may be completed by an integrated logic circuit of hardware or an instruction in the form of software in the processor 1801. The processor 1801 may be a general-purpose processor, a digital signal processor (DSP), an ASIC, a field-programmable gate array (FPGA) or another programmable logic device, a discrete gate or transistor logic device, or a discrete hardware component. The general-purpose processor may be a microprocessor, or the processor may be any conventional processor, or the like. The steps of the method disclosed with reference to the embodiments of the present disclosure may be directly performed by a hardware decoding processor, or may be performed and completed by a combination of hardware and software modules in a decoding processor. A software module may be located in the memory 1802, for example, a random access memory, a flash memory, a read-only memory, a programmable read-only memory, an electrically erasable programmable memory, a register, or other mature storage media in the art. The processor 1801 reads information in the memory 1802, and completes the steps of the above method in combination with the hardware thereof.

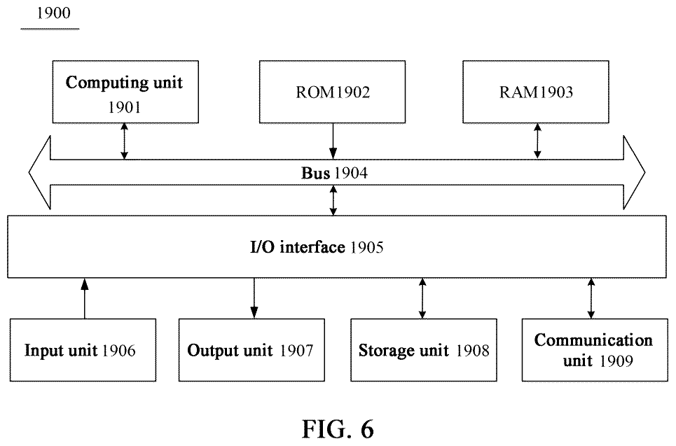

In addition, in a case where various operations/processing according to the present disclosure are implemented by software and/or firmware, programs constituting the software may be installed from a storage medium or a network to a computer system having a dedicated hardware structure, for example, a computer system 1900 shown in FIG. 6, and when various programs are installed in the computer system, the computer system may execute various functions, including the functions as described above, and so on. FIG. 6 is a structural block diagram of a computer system provided in an exemplary embodiment of the present disclosure.

The computer system 1900 is intended to represent various forms of digital electronic computer devices, such as laptop computers, desktop computers, workstations, personal digital assistants, servers, blade servers, mainframe computers, and other suitable computers. The electronic device may also represent various forms of mobile apparatuses, such as personal digital assistants, cellular phones, smart phones, wearable devices, and other similar computing apparatuses. Components shown herein, connections and relationships of the components, and functions of the components are merely examples, and are not intended to limit the implementations of the present disclosure described and/or required herein.

As shown in FIG. 6, the computer system 1900 includes a computing unit 1901, which may execute various suitable actions and processing in accordance with a computer program stored in a read-only memory (ROM) 1902 or a computer program loaded from a storage unit 1908 into a random access memory (RAM) 1903. In the RAM 1903, various programs and data needed by the operations of the computer system 1900 are also stored. The computing unit 1901, the ROM 1902 and the RAM 1903 are connected to each other via a bus 1904. An input/output (I/O) interface 1905 is also connected to the bus 1904.

A plurality of components in the computing system 1900 may be connected to the I/O interface 1905, including: an input unit 1906, an output unit 1907, a storage unit 1908 and a communication unit 1909. The input unit 1906 may be any type of device capable of inputting information to the computer system 1900, the input unit 1906 may receive input digital or character information, and generate a key signal input related to user settings and/or function control of the electronic device. The output unit 1907 may be any type of device capable of presenting information, and may include, but is not limited to, a display, a speaker, a video/audio output terminal, a vibrator, and/or a printer. The storage unit 1908 may include, but is not limited to, a magnetic disk and an optical disk. The communication unit 1909 allows the computer system 1900 to exchange information/data with other devices over a network, such as the Internet, and may include, but is not limited to, a modem, a network card, an infrared communication device, a wireless communication transceiver, and/or a chipset, such as a Bluetooth™ device, a WiFi device, a WiMax device, a cellular communication device, and/or analogues.

The computing unit 1901 may be various general-purpose and/or special-purpose processing components having processing and computing capabilities. Some examples of the computing unit 1901 include, but are not limited to, a central processing unit (CPU), a graphics processing unit (GPU), various dedicated artificial intelligence (AI) computing chips, various computing units for running machine learning model algorithms, a digital signal processor (DSP), and any suitable processors, controllers, micro-controllers, and the like. The computing unit 1901 executes the methods and processing as described above. For example, in some embodiments, the method disclosed in the embodiments of the present disclosure may be implemented as a computer software program, which is tangibly contained in a machine-readable medium, for example, the storage unit 1908. In some embodiments, some or all computer programs may be downloaded and installed on the electronic device 1900 via the ROM 1902 and/or the communication unit 1909. In some embodiments, the computing unit 1901 may be configured to execute the method disclosed in the embodiments of the present disclosure in any other suitable manners (for example, by means of firmware).

An embodiment of the present disclosure further provides a computer-readable storage medium, wherein when an instruction in the computer-readable storage medium is executed by a processor of an electronic device, the electronic device is caused to execute the above method disclosed in the embodiments of the present disclosure.

The computer-readable storage medium in the embodiments of the present disclosure may be a tangible medium, which may contain or store a program that is used by or in combination with an instruction execution system, apparatus or device. The computer-readable storage medium may include, but is not limited to, an electronic, magnetic, optical, electromagnetic, infrared, or semiconductor system, apparatus or device, or a combination of any of the above. More specifically, the computer-readable storage medium may include an electrical connection having one or more wires, a portable computer magnetic disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination of the above.

The computer-readable medium may be contained in the above electronic device; and it may also be present separately and is not assembled into the electronic device.

An embodiment of the present disclosure further provides a computer program product, including a computer program, wherein the computer program, when executed by a processor, implements the above method disclosed in the embodiments of the present disclosure.

In the embodiments of the present disclosure, computer program codes for executing the operations of the present disclosure may be written in one or more programming languages or combinations thereof. The programming languages include, but are not limited to, object node-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network (including a local area network (LAN) or a wide area network (WAN)), or it may be connected to an external computer.

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially in parallel, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The modules, components or units involved in the described embodiments of the present disclosure may be implemented in a software or hardware manner. The names of the modules, components or units do not constitute limitations of the modules, components or units themselves in a certain case.

The functions described herein above may be executed, at least in part, by one or more hardware logical components. For example, without limitation, example types of the hardware logical components that may be used include: a field programmable gate array (FPGA), an application specific integrated circuit (ASIC), an application specific standard product (ASSP), a system on chip (SOC), a complex programmable logic device (CPLD), and so on.

What have been described above are only some embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to).

Although some specific embodiments of the present disclosure have been described in detail by way of examples, those skilled in the art should understand that the above examples are for illustration only and are not intended to limit the scope of the present disclosure. Those skilled in the art should understand that the above embodiments may be modified without departing from the scope and spirit of the present disclosure. The scope of the present disclosure is defined by the appended claims.

I/We claim:

1. A method for controlling a code rate of live streaming, comprising:
obtaining code rate information of a stream push of live streaming in an application layer of a terminal;
obtaining a target bandwidth estimation value obtained by a transport layer of the terminal; and
adjusting the target bandwidth estimation value based on the code rate information, and determining a target code rate of the terminal based on the adjusted target bandwidth estimation value.

2. The method according to claim 1, wherein adjusting the target bandwidth estimation value based on the code rate information comprises:
obtaining a target resolution corresponding to a video frame to be transmitted;
obtaining a target code table corresponding to the target resolution, wherein the target code table comprises an upper code rate limit value and a lower code rate limit value, and different resolutions correspond to different code tables; and
in response to the target bandwidth estimation value being less than the lower code rate limit value, adjusting the target bandwidth estimation value based on the lower code rate limit value.

3. The method according to claim 1, wherein adjusting the target bandwidth estimation value based on the code rate information comprises:
obtaining a first code rate corresponding to (i-1)^{th} period, wherein the target bandwidth estimation value is obtained within i^{th} period, and i is a positive integer greater than 1;
obtaining a code rate change value based on the first code rate and the target bandwidth estimation value; and
in response to the code rate change value being not greater than a change threshold, using the first code rate as the adjusted target bandwidth estimation value.

4. The method according to claim 1, comprising:
obtaining an initial bandwidth estimation value estimated during the stream push of live streaming; and
in response to determining that a bandwidth oscillation fluctuation mode is entered based on the bandwidth estimation value, performing filtering processing on the initial bandwidth estimation value to obtain the target bandwidth estimation value, wherein the bandwidth oscillation fluctuation mode represents a decrease situation of the bandwidth estimation value within a unit time period.

5. The method according to claim 4, wherein the initial bandwidth estimation value comprises a plurality of bandwidth estimation values obtained according to a time sequence, and the method further comprises:
obtaining decrease values between every two adjacent bandwidth estimation values among the plurality of bandwidth estimation values;
in response to a target decrease value among the decrease values being greater than a decrease threshold, obtaining an interval duration between the target decrease values;
in response to the interval duration being less than a threshold duration, obtaining a number of occurrence times of the target decrease value within a unit time; and
in response to the number of occurrence times being greater than a threshold of the number of occurrence times, determining that the bandwidth oscillation fluctuation mode is entered.

6. The method according to claim 4, wherein the method further comprises:
determining, based on the initial bandwidth estimation value, whether a current stage is in a starting stage, wherein the starting stage comprises that the initial bandwidth estimation value is in a consecutively increasing state; and
in response to the current stage being not in the starting stage, determining whether the bandwidth oscillation fluctuation mode is entered.

7. The method according to claim 4, wherein performing filtering processing on the initial bandwidth estimation value to obtain the target bandwidth estimation value comprises:
obtaining a current code rate of the stream push of live streaming; and
determining the target bandwidth estimation value based on the current code rate, the initial bandwidth estimation value, and a preset bandwidth smoothing factor coefficient.

8. The method according to claim 4, further comprising:
in response to the bandwidth oscillation fluctuation mode being not entered, using the initial bandwidth estimation value as the target bandwidth estimation value.

9. An electronic device, comprising:
at least one processor; and
a memory, configured to store instructions executable by the at least one processor,
wherein the at least one processor is configured to execute the instructions to cause the electronic device to:
obtain code rate information of a stream push of live streaming in an application layer of a terminal;
obtain a target bandwidth estimation value obtained by a transport layer of the terminal; and
adjust the target bandwidth estimation value based on the code rate information, and determine a target code rate of the terminal based on the adjusted target bandwidth estimation value.

10. The electronic device according to claim 9, wherein the instructions executed to cause the electronic device to adjust the target bandwidth estimation value based on the code rate information further cause the electronic device to:
obtain a target resolution corresponding to a video frame to be transmitted;
obtain a target code table corresponding to the target resolution, wherein the target code table comprises an upper code rate limit value and a lower code rate limit value, and different resolutions correspond to different code tables; and
in response to the target bandwidth estimation value being less than the lower code rate limit value, adjust the target bandwidth estimation value based on the lower code rate limit value.

11. The electronic device according to claim 9, wherein the instructions executed to cause the electronic device to adjust the target bandwidth estimation value based on the code rate information further cause the electronic device to:
obtain a first code rate corresponding to (i-1)^{th} period, wherein the target bandwidth estimation value is obtained within i^{th} period, and i is a positive integer greater than 1;
obtain a code rate change value based on the first code rate and the target bandwidth estimation value; and
in response to the code rate change value being not greater than a change threshold, use the first code rate as the adjusted target bandwidth estimation value.

12. The electronic device according to claim 9, wherein the electronic device is further caused to:
obtain an initial bandwidth estimation value estimated during the stream push of live streaming; and
in response to determining that a bandwidth oscillation fluctuation mode is entered based on the bandwidth estimation value, perform filtering processing on the initial bandwidth estimation value to obtain the target bandwidth estimation value, wherein the bandwidth oscillation fluctuation mode represents a decrease situation of the bandwidth estimation value within a unit time period.

13. The electronic device according to claim 12, wherein the initial bandwidth estimation value comprises a plurality of bandwidth estimation values obtained according to a time sequence, and the electronic device is further caused to:
obtain decrease values between every two adjacent bandwidth estimation values among the plurality of bandwidth estimation values;
in response to a target decrease value among the decrease values being greater than a decrease threshold, obtain an interval duration between the target decrease values;
in response to the interval duration being less than a threshold duration, obtain a number of occurrence times of the target decrease value within a unit time; and
in response to the number of occurrence times being greater than a threshold of the number of occurrence times, determine that the bandwidth oscillation fluctuation mode is entered.

14. The electronic device according to claim 12, wherein the electronic device is further caused to:
determine, based on the initial bandwidth estimation value, whether a current stage is in a starting stage, wherein the starting stage comprises that the initial bandwidth estimation value is in a consecutively increasing state; and
in response to the current stage being not in the starting stage, determine whether the bandwidth oscillation fluctuation mode is entered.

15. The electronic device according to claim 12, wherein the instruction executed to cause the electronic device to perform filtering processing on the initial bandwidth estimation value to obtain the target bandwidth estimation value further cause the electronic device to:
obtaining a current code rate of the stream push of live streaming; and
determining the target bandwidth estimation value based on the current code rate, the initial bandwidth estimation value, and a preset bandwidth smoothing factor coefficient.

16. The electronic device according to claim 12, wherein the electronic device is further caused to:
in response to the bandwidth oscillation fluctuation mode being not entered, use the initial bandwidth estimation value as the target bandwidth estimation value.

17. A non-transitory computer-readable storage medium, wherein when instructions in the computer-readable storage medium is executed by a processor of an electronic device, the electronic device is caused to:
obtain code rate information of a stream push of live streaming in an application layer of a terminal;
obtain a target bandwidth estimation value obtained by a transport layer of the terminal; and
adjust the target bandwidth estimation value based on the code rate information, and determine a target code rate of the terminal based on the adjusted target bandwidth estimation value.

18. The non-transitory computer-readable storage medium according to claim 17, wherein the instructions executed to cause the electronic device to adjust the target bandwidth estimation value based on the code rate information further cause the electronic device to:
obtain a target resolution corresponding to a video frame to be transmitted;
obtain a target code table corresponding to the target resolution, wherein the target code table comprises an upper code rate limit value and a lower code rate limit value, and different resolutions correspond to different code tables; and
in response to the target bandwidth estimation value being less than the lower code rate limit value, adjust the target bandwidth estimation value based on the lower code rate limit value.

19. The non-transitory computer-readable storage medium according to claim 17, wherein the instructions executed to cause the electronic device to adjust the target bandwidth estimation value based on the code rate information further cause the electronic device to:
obtain a first code rate corresponding to (i-1)^{th} period, wherein the target bandwidth estimation value is obtained within i^{th} period, and i is a positive integer greater than 1;
obtain a code rate change value based on the first code rate and the target bandwidth estimation value; and
in response to the code rate change value being not greater than a change threshold, use the first code rate as the adjusted target bandwidth estimation value.

20. The non-transitory computer-readable storage medium according to claim 17, wherein the electronic device is further caused to:
obtain an initial bandwidth estimation value estimated during the stream push of live streaming; and
in response to determining that a bandwidth oscillation fluctuation mode is entered based on the bandwidth estimation value, perform filtering processing on the initial bandwidth estimation value to obtain the target bandwidth estimation value, wherein the bandwidth oscillation fluctuation mode represents a decrease situation of the bandwidth estimation value within a unit time period.
